(19) United States
(12) Patent Application Publication
(10) Pub. No.: US 2013/0318764 A1
(43) Pub. Date: Dec. 5, 2013

(54) QUICK RELEASE AND ATTACH WALL MOUNT DEVICE FOR HANGING AN OBJECT

(71) Applicants: Jeffrey Frey, Escondido, CA (US); James Naubert Hamilton, JR., Portland, ME (US)

(72) Inventors: Jeffrey Frey, Escondido, CA (US); James Naubert Hamilton, JR., Portland, ME (US)

(21) Appl. No.: 13/482,211

(22) Filed: May 29, 2012

(51) Int. Cl. A47F 5/08; A47F 5/00; B23P 17/04

(52) U.S. Cl. 29/428; 248/231.91; 248/291.1

(57) ABSTRACT

The hangar embodiments disclosed relate to a device and method for quickly changing out old pictures, quilts, etc. The device includes a back board that is attachable to a wall. A faceboard is rotateably attachable to the back board. A friction material is disposed between the backboard in the faceboard and used to hold up the flat object when the faceboard is traversed to the closed position.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The embodiments disclosed herein relate to a hangar used to mount a flat object to a wall.

Current methods of mounting a flat object to a wall are quite cumbersome. They typically require modifications to the upper edge of the flat object. By way of example and not limitation, U.S. Pat. No. 5,040,586 discloses a flat object (i.e., banner) that has a modified upper edge. The upper edge is reinforced and has a plurality of holes which receive a plurality of pins that are formed in the mounting device. An outer cover prevents the upper edge of the flat object from slipping out of the pin when the outer cover is traversed to the closed position. The same general concept is also shown in United States Publication No. 2004/0163295. U.S. Pat. No. 6,219,892 requires that the upper edge of the flat object be modified with a bar that is entrapped within a cavity of the mounting device.

Accordingly, there is a need in the art for an improved mounting device.

### BRIEF SUMMARY

The various embodiments of the mounting device disclosed herein addresses the needs disclosed above, discussed below and those that are known in the art.

A mounting device is disclosed herein which does not require the flat object to be modified to work with the mounting device. Rather, the mounting device works with any type of flat object for mounting the flat object to a wall. Moreover, the mounting device allows for quick changeovers so that the user can quickly and easily replace a first flat object with a second flat object and vice: versa. In particular, the mounting device may have a backboard that is mountable to a vertical wall. A hinge may be mounted to the upper edge portion of the backboard. The hinge may also be attached to a faceboard which is traversable between a closed position and an opened position. In the open position, the flat object may be inserted between the backboard and the faceboard or removed therefrom. In the closed position, the flat object is compressed or held in place between the backboard and the faceboard. The faceboard is biased to at least the closed position but may be biased to both the open and closed positions. The biasing of the faceboard to the closed position may be accomplished via spring, magnets or other methods known in the art developed in the future. One or more friction materials may be mounted to the front side of the backboard and/or the backside of the faceboard. When the faceboard is in the closed position, the flat object is in frictional engagement with the friction material. This frictional engagement there between secures the flat object to the mounting device.

More particularly, a device for quick release and attachment of a flat object to a vertical structure is disclosed. The device may comprise a backboard, a faceboard, a friction material, and one or more hinges connecting the backboard and faceboard. The backboard may have a length about equal to or greater than a width of the object. The backboard may define an upper edge and a front surface. The backboard may be attached to the vertical structure. The friction material may be attached to the front surface of the back board. The friction material may extend or protrude out of the front surface. The faceboard may be pivotally attached to the upper edge of the backboard. The faceboard may be traversable between an opened position wherein the faceboard does not cover the front surface of the backboard and a closed position wherein the faceboard covers the front surface of the backboard.

The one or more hinges may be attached to the back board and the faceboard for allowing pivotal movement of the faceboard with respect to the backboard. The hinges may be biased to the closed position for biasing the faceboard to the closed position. Alternatively, the hinges may be unbiased or freely rotatable and the faceboard may be biased to the closed position by magnets. As a further alternative, the hinges may be biased to the opened position with springs, whereas the faceboard is biased to the closed position.

The back surface of the faceboard may contact the friction material when the faceboard is in the closed position so that the object can be attached between the back board and the faceboard and quickly changed out by traversing the faceboard to the opened position. Alternatively, there may be a small gap between the friction material and the back surface of the faceboard. This small gap may be smaller than a thickness of the flat object so that the back surface of the faceboard may press against the flat object and the flat object a press against the friction material.

The device may comprise additional faceboards which are lined end to end and collectively extend across the length of the back board. As such, the device is scalable so that wider or narrower flat objects can be hung with the device. Moreover, for very wide flat objects, one person can hang the wide flat object to the device by sequentially mounting small sections of the flat object to each of the faceboard and backboard combinations.

The friction material may be an elongate material that is attached to the front surface of the backboard along the length of the back board. The friction material may be disposed closer to an upper edge of the faceboard compared to a lower edge of the faceboard. The friction material may be fabricated from a rubber or an elastomeric material. An additional friction material may also be attached to a back surface of the faceboard. Multiple combinations and arrangements of the friction material to the front surface of the backboard and the back surface of the faceboard are contemplated.

The front surface may have an elongate groove sized and configured to receive the elongate material. A depth of the groove may be smaller than a height of the friction material so that the friction material protrudes out of the front surface of the backboard.

In the device, a biasing force of the hinge may be sufficiently strong to hold the flat object. The biasing farce may be produced with a spring or magnet.

In another aspect, a device for quick release and attachment of a flat object to a vertical structure is disclosed. The device may comprise a backboard, faceboard, friction material and one or more hinges. The backboard may have a length about equal to or greater than a width of the object. The backboard may define an upper edge. The backboard may be attached to the vertical structure. The faceboard may be pivotally attached to the upper edge of the backboard. The faceboard may be traversable between an open position wherein the faceboard does not cover the front surface of the backboard and a closed position wherein the faceboard covers the front surface of the backboard. The faceboard may define a back surface.

The friction material may be attached to the back surface of the faceboard. The friction material may extend out of the back surface. It is also contemplated that the friction material may be attached to the front surface of the backboard. The friction material may extend out of the front surface.

The one or more hinges may be attached to the backboard and the faceboard for allowing pivotal movement of the faceboard with respect to the backboard. The hinges may be biased to the closed position for biasing the faceboard to the closed position. Such biasing may be accomplished with the spring or magnet. It is also contemplated that the hinges may be freely rotating and that the biasing may be accomplished with the magnet.

The back surface of the faceboard may contact the friction material when the faceboard is in the closed position so that the object can be attached between the back board and the faceboard and quickly changed out by traversing the faceboard to the opened and closed positions.

In another aspect, a method of hanging a flat object on a vertical structure is disclosed. The method may comprise the steps of pivoting a faceboard of a device upward to an opened position; positioning an edge of the flat object against a backboard of the device; rotating the faceboard downward toward a closed position; and biasing the faceboard against the flat object and a friction material attached to a front surface of the backboard.

The method may also further comprise the steps of pivoting the first and second faceboards of the device upward to the opened position; positioning a first portion of the edge of the flat object against the backboard of the device; rotating the first faceboard downward toward the closed position; biasing the first faceboard against the flat object and the friction material attached to the front surface of the backboard; positioning a second portion of the edge of the flat object against the backboard of the device; rotating the second faceboard downward toward the closed position; and biasing the second faceboard against the flat object and the friction material attached to the front surface of the backboard.

In the method, the friction material may be an elongate strip extending across a length of the backboard or a plurality of small members attached to the front surface of the backboard.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a device for quick attachment and removal of a flat object to be mounted on a vertical structure;

FIG. 2A is an enlarged perspective view of the device shown in FIG. 1 wherein faceboard is in a closed position;

FIG. 2B is an enlarged perspective view of the device shown in FIG. 1 wherein the faceboard is in an open position;

FIG. 3 is a side view of the device shown in FIG. 2A;

FIG. 4 is a side view of the device shown in FIG. 2A with an additional friction strip illustrating a second embodiment;

FIG. 5 is a side view of the device shown in FIG. 2A illustrating a third embodiment wherein the friction strip is mounted to the faceboard instead of the backboard; and

FIG. 6 is a side view of the device shown in FIG. 2A illustrating a fourth embodiment wherein the friction strips are mounted to both the faceboard and the backboard.

### DETAILED DESCRIPTION

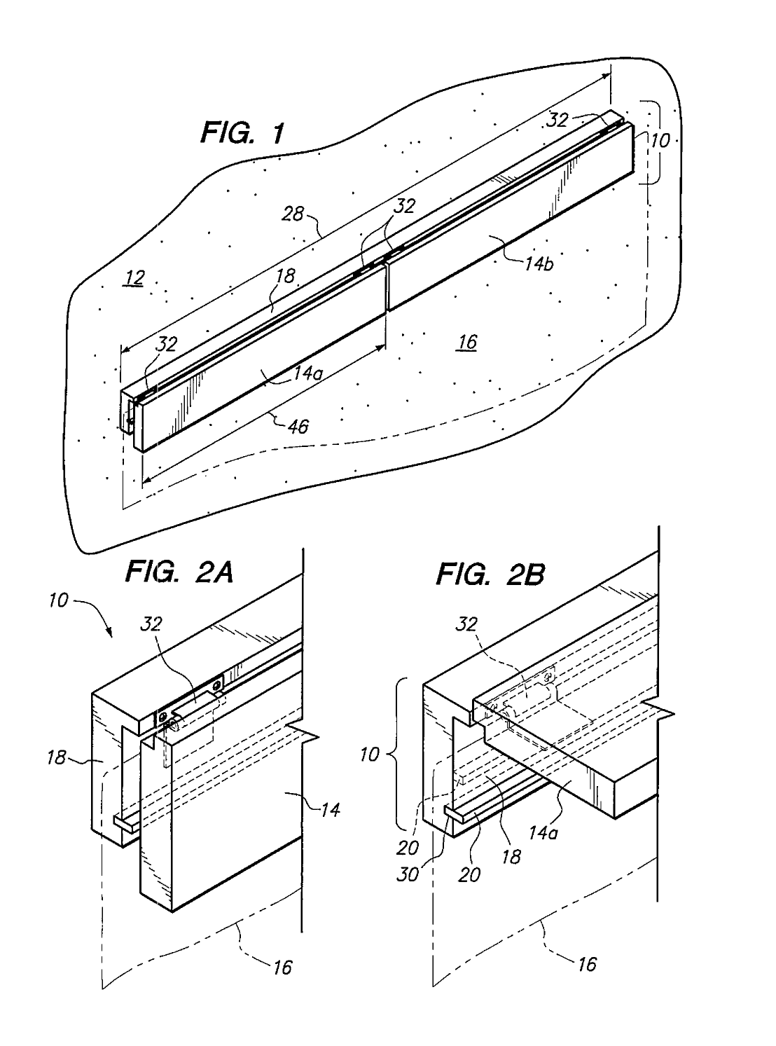

Referring now the drawings, a mounting device 10 is shown. The mounting device 10 may be attached to a vertical wall 12. The device 10 may have one or more faceboards 14 that can be traversed to the closed position shown in FIG. 1 to hold a flat object 16. To change out the flat object 16 with a different flat object 16 or to remove the flat object 16, the faceboards 14a, b can be rotated toward the opened position as shown in FIG. 2B. When the faceboards 14a, b are flipped up to the opened position, the flat object 16 may be removed from the mounting device 10. As shown in FIG. 2A, the mounting device 10 may have a backboard 18 which may have a friction material 20 which extends across the length of the backboard 18 and frictionally engages the flat object 16 when the faceboards 14a, b are in the closed position to prevent the flat object 16 from falling out of the mounting device 10.

More particularly, the backboard 18 may define an upper edge portion 22 and a front face 24. The backboard 18 is attachable to the wall 12 with a wall screw, adhesive and other attachment means known in the art or developed in the future. The front face 24 is preferably parallel to an exterior surface 26 of the wall 12 but may be at other inclined or declined angles. The backboard 18 may also have an elongated groove that extends along the entire length 28 of the backboard 18. Alternatively, the groove 30 may also be formed as a plurality of groove sections along the length 28 of the backboard 18. In all cases, at least one groove 30 is lined up with the faceboard 14a and at least one groove 30 is lined up with the faceboard 14b. If the device 10 only has one faceboard 14, then one or more grooves are formed in the backboard 18. Preferably, one groove extends substantially along the entire length of the backboard 18 or a plurality of grooves is distributed substantially along the entire length of the backboard 18.

The friction material 20 may be disposed within the one or more of the grooves 30 and protrude out of the front face 24 of the backboard 18. The friction material 20 may be secured to the groove 30 by way of friction between the friction material 20 and internal surface of the groove 30. Additionally or alternatively, the friction material 20 may be secured within the groove 30 by other means known in the art such as adhesive, tacks, etc. By way of example and not limitation, the friction material 20 may be a strip of weather stripping. The friction material 20 may be fabricated from any type of material that exhibits a high coefficient of friction. These types of materials include but are not limited to: elastomeric materials, rubber materials, tack strip, carpet tack strip, etc. If a tack strip is used, the tacks may be pointed upward so that the weight of the flat object grips into the tacks and the object is securely held in place.

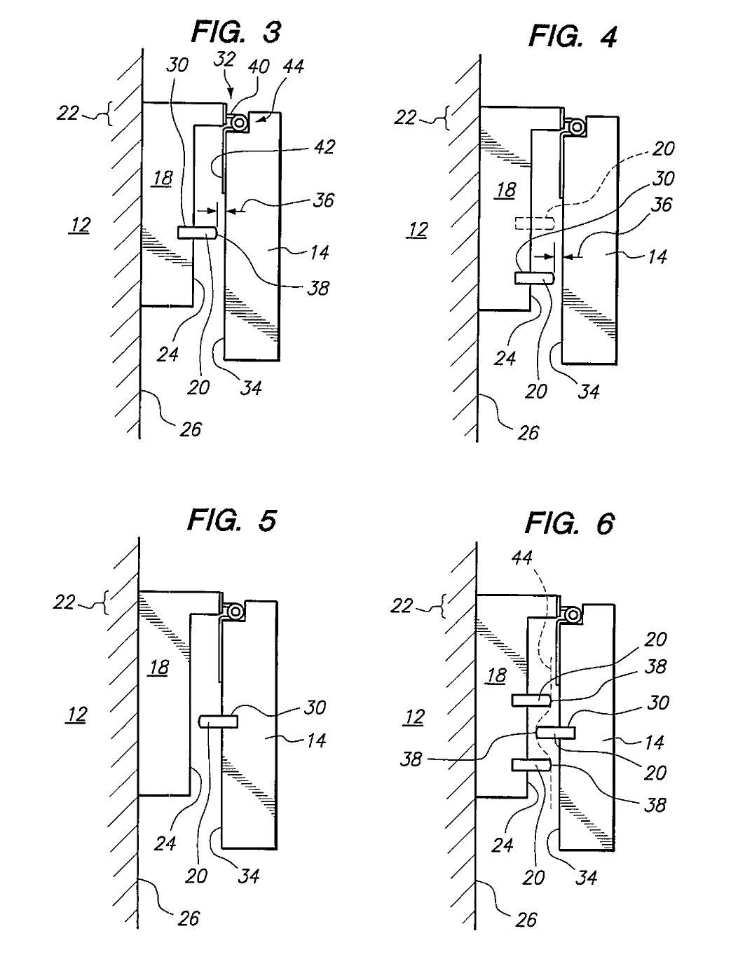

Referring now to FIGS. 1 and 3, when the faceboard 14a is traversed to the closed position, the flat object 16 presses against the friction material 20 disposed in the groove 30. Similarly, when the faceboard 14b is traversed to the closed position, the flat object 16 is frictionally engaged to the friction material 20 disposed within the groove 30, protruding out of the front surface 24 of the backboard 18 and aligned with the faceboard 14b. The friction material 20 is shown as extending out perpendicularly to the front surface 24 of the backboard 18. However, it is also contemplated that the friction material 20 may extend out at various other angles. By way of example and not limitation, the friction material 20 may extend out of the front surface 24 at an upward angle. The weight of the flat object 16 may cause the friction material 20 to bend slightly downward. This slight bending downward of the friction material causes the friction material 20 to further push against the faceboards 14a, b. This increases the friction force between the friction material 20 and the flat object 16 to help facilitate holding of the flat object 16 in the device 10. The distal end surface 38 of the friction material may additionally have horizontal ribs (not shown) that extend along the length of the friction material 20. These ribs further help frictional engagement between the friction material 20 and the flat object 16. It is also contemplated that the friction material may extend out of the front surface 24 with a downward angle.

The faceboards 14a, b may be pivotally attached to the backboard 18 through a hinge mechanism 32. The hinge mechanism 32 may be biased to the closed position as shown in FIG. 2A and also biased to the opened position as shown in FIG. 2B. In the closed position, the hinge 32 urges a back surface 34 of the faceboards 14a, b toward the friction material 20. It is not necessary for the back surface 34 to contact the friction material 20, but a gap 36 between the friction material 20 and the back surface 34 must be less than a thickness of the flat object 16 so that the faceboards 14a, b may press the flat object 16 against the friction material 20. The hinge mechanism 32 may be hinge Amerock 7139 sold by Amerock Hardware.

The hinge 32 may include first and second members 40, 42. The first member 40 may be attached to the backboard 18 at the upper edge portion of the backboard 18 through one or more ways known in the art or developed in the future. The same is true for the second member 42 which may be attached to the back surface of the faceboard 14 through one or more ways known in the art or developed in the future. The hinge 32 is mounted behind the faceboard so that the hinge 32 is not visible from the front. The hinge 32 is hidden behind a veneer 44.

The friction material configuration may have various configurations as shown in FIGS. 4-6. By way of example and not limitation, as shown in FIG. 4, one or more additional friction materials 20 may be disposed above the existing friction material 20. It is also contemplated that the friction material 20 may be disposed below the existing friction material 20. As an additional alternative embodiment, it is also contemplated that there may be a 1st row of a plurality of friction materials 20 and a 2nd row of a plurality of friction materials 20. The 1st row of the plurality of friction materials 20 may be staggered (or aligned) with the 2nd row of the plurality of friction materials 20.

Referring now to FIG. 5, the friction material 20 may be mounted to the back surface 34 of the faceboard 14 instead of the backboard 18. To do so, a groove 30 is formed in the back surface 34 of the faceboard 14. The groove 30 may extend across the entire length of the faceboard 14. The friction material 20 may be inserted and mounted into the groove 30. The friction material 20 may extend substantially along the entire length of the groove 30. It is also contemplated that a plurality of grooves 30 may be formed along the length of the back surface of the faceboard 14. A plurality of friction materials 20 may be inserted into the plurality of grooves 30. In another embodiment, one single groove 30 may extend substantially across entire length of the faceboard 14. A plurality of short segmented friction materials 20 may be distributed along the single groove 30. It is also contemplated that one or more additional rows of friction material 20 may be disposed above or below the existing strip of friction material. If two or more rows of friction materials 20 are mounted to the back side of the faceboard 14, the rows of friction material may comprise a plurality of short segmented friction materials 20 that are staggered (or aligned) with respect to the upper and lower rows of friction materials 20.

Referring now to FIG. 6, a further alternative configuration for the friction materials 20 is shown. The friction materials 20 may be embedded into both the front surface 24 of the backboard 18 as well as the back surface 34 of the faceboard 14. The friction materials 20 may be offset as shown in FIG. 6. The distal end surface 38 of the friction material 20 is embedded into the faceboard 14 and may also be disposed past a plane 44 defined by the distal end surfaces 38 of the friction materials 20 embedded in the backboard 18.

Referring back to FIG. 1, the device 10 is shown as having two faceboards 14a, b. The length 46 of any one of the faceboards 14a, b may be 3 inches to 6 feet. Preferably, the length 46 of each of the faceboards 14 that make up the device 10 have a common length. The traversal of any one of the faceboards to the opened position or the closed position may be independent of the other faceboards. Preferably, each of the faceboards 14 has at least 2 hinge mechanisms 32 position at opposed ends of the faceboard 14. This is to provide as much stability and structural support to the faceboard 14 as possible.

To install the device 10, the user attaches the backboard 18 to a wall with one or more attachment means known in the art or developed in the future. By way of example and not limitation, the backboard may be attached to the wall with a screw that engages a stud of the wall. Preferably, the backboard 18 is installed horizontally or leveled with the ground. The screws may be hidden behind the faceboards 14a, b.

To mount the flat object 16 to the device 10 after installation, the user traverses each of the 14a, b to the open position. The friction materials 20 are now exposed. The flat object 16 is laid against the backboard 18. The user traverses one of the faceboards 14 to the closed position. The flat object 16 is adjusted. The flat object 16 can then be adjusted and the next faceboard 14 can be traversed to the closed position. This process is repeated until all of the faceboards 14 are traversed to the closed position. Throughout the entire process, the flat object 16 can be slightly adjusted to be squared with other fixtures on the wall for aesthetic reasons. When the device 10 comprises a plurality of faceboards 14, the process may begin from the leftmost side and the user may work his or her way to the rightmost side, and vice versa. Alternatively, the user may begin from the middle and work his or her way to the leftmost side then to the rightmost side.

The flat object 16 referred to in this description may be a quilt, picture, paper, sheet or any other generally planar material. The hinge mechanism 32 may be spring biased. Other types of biasing devices are also contemplated such as magnets. Attractive magnets may be embedded in the backboard 18 and the faceboards 14. The user may lift up the faceboards 14 and slip the flat object 16 between the backboard 18 and the faceboard 14. When the user traverses the faceboard 14 to the closed position, the attraction of the magnets biases the faceboard 14 against the backboard 18. The hinge mechanism 32 is also described as being biased at both the opened position as well as closed position. However, it is contemplated that the hinge mechanism 32 may be biased solely in the closed position. By way of example and not limitation, the magnets may be embedded in the backboard 18 and the faceboards 14 to bias the faceboards 14 to the closed position. The hinge mechanism 32 may be a freely rotating hinge.

The friction material 20 disclosed herein may be fabricated from an elastomeric material. This means that the friction material may compress and bend as needed. The backboard 18 may be fabricated from wood. As such, the backboard 18 may not be perfectly straight. Moreover, the vertical structure may also be a wall which is also known to be slightly curved due to modern construction techniques. Nonetheless, the elastomeric friction material accommodates such imperfection. When the faceboard 14 is traversed to the closed position, the backside of the faceboard 14 pushes the flat object 16 against the friction material 20. Even though the wall and/or the backboard 18 may be curved or not straight, the friction material due to its elastomeric properties accommodates for such imperfection.

The above description is given by way of example, and not limitation. Given the above disclosure, one skilled in the art could devise variations that are within the scope and spirit of the invention disclosed herein, including various ways of attaching the device to the vertical structure. Further, the various features of the embodiments disclosed herein can be used alone, or in varying combinations with each other and are not intended to be limited to the specific combination described herein. Thus, the scope of the claims is not to be limited by the illustrated embodiments.

1. A device for quick release and attachment of a flat object to a vertical structure, the device comprising:
a back board having a length about equal to or greater than a width of the object, the backboard defining an upper edge and a front surface, the backboard being attachable to the vertical structure;
a friction material attached to the front surface of the back board, the friction material extending out of the front surface;
a faceboard pivotally attached to the upper edge of the backboard, the faceboard being traversable between an open position wherein the freeboard does not cover the front surface of the backboard and a closed position wherein the faceboard covers the front surface of the backboard;
one or more hinges attached to the back board and the faceboard for allowing pivotal movement of the faceboard with respect to the backboard, the hinges being biased to the closed position for biasing the faceboard to the closed position;
wherein a back surface of the faceboard contacts the friction material when the faceboard is in the closed position so that the object can be attached between the back board and the faceboard and quickly changed out by traversing the faceboard to the opened position.

2. The device of claim 1 further comprising additional faceboards which are lined end to end and collectively extend across the length of the back board so that one person can hang the flat object to the device.

3. The device of claim 1 wherein the friction material is an elongate material that is attached to the front surface of the backboard along the length of the back board.

4. The device of claim 3 wherein the front surface has an elongate groove sized and configured to receive the elongate material and a depth of the groove is smaller than a height of the friction material.

5. The device of claim 1 wherein the friction material is rubber or a tack strip.

6. The device of claim 1 wherein a biasing force of the hinge is sufficiently strong to hold the flat object.

7. The device of claim 1 wherein the friction material is disposed closer to an upper edge of the faceboard compared to a lower edge of the faceboard.

8. The device of claim 1 further comprising a friction material attached to a back surface of the faceboard.

9. A device for quick release and attachment of a flat object to a vertical structure, the device comprising:
a back board having a length about equal to or greater than a width of the object, the backboard defining an upper edge, the backboard being attachable to the vertical structure;
a faceboard pivotally attached to the upper edge of the backboard, the faceboard being traversable between an open position wherein the faceboard does not cover the front surface of the backboard and a closed position wherein the faceboard covers the front surface of the backboard, the faceboard defining a back surface;
a friction material attached to the back surface of the faceboard, the friction material extending out of the back surface;
one or more hinges attached to the back board and the faceboard for allowing pivotal movement of the faceboard with respect to the backboard, the hinges being biased to the closed position for biasing the faceboard to the closed position;
wherein a back surface of the faceboard contacts the friction material when the faceboard is in the closed position so that the object can be attached between the back board and the faceboard and quickly changed out by traversing the faceboard to the opened position.

10. A method of hanging a flat object on a vertical structure, the method comprising the steps of:
pivoting a faceboard of a device upward to an open position;
positioning an edge of the flat object against a backboard of the device;
rotating the faceboard downward toward a closed position;
biasing the faceboard against the flat object and a friction material attached to a front surface of the backboard.

11. The method of claim 10 further comprising the steps of:
pivoting first and second faceboards of the device upward to the open position;
positioning a first portion of the edge of the flat object against the backboard of the device;
rotating the first faceboard downward toward the closed position;
biasing the first faceboard against the flat object and the friction material attached to the front surface of the backboard;
positioning a second portion of the edge of the flat object against the backboard of the device;
rotating the second faceboard downward toward the closed position;
biasing the second faceboard against the flat object and the friction material attached to the front surface of the backboard.

12. The method of claim 10 wherein the friction material is an elongate strip extending across a length of the backboard or a plurality of small members attached to the front surface of the backboard.
